(19) United States
(12) Patent Application Publication
(10) Pub. No.: US 2024/0316714 A1
(43) Pub. Date: Sep. 26, 2024

(54) MOVEMENT ROUTE DETERMINATION DEVICE AND NON-TRANSITORY COMPUTER-READABLE MEDIUM STORING A COMPUTER PROGRAM

(71) Applicant: FANUC CORPORATION, Yamanashi (JP)

(72) Inventor: Nobuhito OONISHI, Yamanashi (JP)

(73) Assignee: FANUC CORPORATION, Yamanashi (JP)

(21) Appl. No.: 18/574,259

(22) PCT Filed: Jul. 21, 2021
(86) PCT No.: PCT/JP2021/027391

§ 371 Date: Dec. 26, 2023

(51) Int. Cl. B23Q 15/12

(52) U.S. Cl. CPC B23Q 15/12

(57) ABSTRACT

Provided is a technology for enabling optimization of a movement route of an axis in a machine configuration having a high degree of freedom. This movement route determination device is provided with: an evaluation formula calculation unit that calculates an evaluation formula for determining a movement route; a constraint condition calculation unit that calculates, as a constraint condition for determining the movement route, an axis relational formula based on machine configuration data of a machine tool; and a route search unit that searches for the movement route on the basis of the evaluation formula and the constraint condition. The route search unit determines the movement route such that a range where search can be performed by the evaluation formula becomes minimum or maximum.

### TECHNICAL FIELD

The present invention relates to a movement route determination device and a computer program.

### BACKGROUND ART

FIG. 11 is a diagram illustrating a conventional typical turning process. In such a conventional typical turning process, a tool T is brought into contact with a rotating workpiece W, thereby machining the workpiece W (for example, see Patent Document 1). According to this turning process, a non-circular contour can be machined by way of combining a rotation axis and a movement axis.

FIG. 12 is a diagram illustrating a turning process called interpolation cutting. As illustrated in FIG. 12, in the interpolation cutting, the workpiece W is machined by synchronizing the rotation of the tool T with the movement of the tool T along the X and Y axes.

FIG. 13 is a diagram illustrating a case where the workpiece W is also rotatable in the interpolation cutting. For the interpolation cutting, in the case of a machine configuration in which the workpiece W is rotatable around the rotation axis C, even if a starting point, an endpoint, a contour shape, and a command velocity are specified, there are a plurality of movement routes for each axis because of an excess degree of freedom, making it impossible to uniquely determine a movement route for each axis. This is apparent from the fact that the tool T and the workpiece W can take plural postures with respect to the same cutting point P, as shown in FIG. 13.

### CITATION LIST

### Patent Document

Patent Document 1: Japanese Unexamined Patent Application, Publication No. H11-216642

### DISCLOSURE OF THE INVENTION

### Problems to be Solved by the Invention

On the other hand, a movement route can be determined by fixing any one of the axes. However, in this case, there is no assurance that the optimum movement route is determined in consideration of the load on the machine tool, etc. For example, it is desirable to reduce movement for an axis with large inertia and movement for a low-precision axis as much as possible.

It is an object of the present disclosure to provide a technique that makes it possible to optimize a movement route for axes in a machine configuration having an excess degree of freedom.

### Means for Solving the Problems

One aspect of the present disclosure is directed to a movement route determination device that determines, in a case where a degree of freedom of axes of a machine tool is higher than a degree of freedom determined by a machining program and a parameter, a movement route for the axes based on the machining program and the parameter. The movement route determination device includes: an evaluation formula calculation unit configured to calculate an evaluation formula for determining the movement route; a constraint condition calculation unit configured to calculate, as a constraint condition for determining the movement route, a relational expression of the axes, the relational expression being based on machine configuration data of the machine tool; and a route search unit configured to search for the movement route based on the evaluation formula and the constraint condition, the movement route being such that the evaluation formula is minimized or maximized within a searchable range.

### Effects of the Invention

The present disclosure makes it possible to optimize a movement route for axes in a machine configuration having an excess degree of freedom.

### BRIEF DESCRIPTION OF THE DRAWINGS

FIG. 1 is a diagram illustrating a configuration of a movement route determination device according to an embodiment of the present disclosure;

FIG. 2 is a flowchart illustrating a procedure of a movement route determination process according to an embodiment of the present disclosure;

FIG. 3 illustrates velocities and accelerations of a workpiece rotation axis Cw, a tool rotation axis Ct, a movement axis X, and a movement axis Y in interpolation cutting in which a workpiece is caused to make one rotation;

FIG. 4 illustrates motions of the workpiece and the tool in interpolation cutting in which the workpiece of FIG. 3 is caused to make one rotation;

FIG. 5 illustrates velocities and accelerations of a workpiece rotation axis Cw, a tool rotation axis Ct, a movement axis X, and a movement axis Y in a first example in which a movement route determination process according to an embodiment of the present disclosure is applied to interpolation cutting in which a workpiece is caused to make one rotation;

FIG. 6 illustrates velocities and accelerations of a workpiece rotation axis Cw, a tool rotation axis Ct, a movement axis X, and a movement axis Y in a second example in which a movement route determination process according to an embodiment of the present disclosure is applied to interpolation cutting in which a workpiece is caused to make one rotation;

FIG. 7 illustrates velocities and accelerations of a workpiece rotation axis Cw, a tool rotation axis Ct, a movement axis X, and a movement axis Y in interpolation cutting in which a workpiece is not caused to make one rotation;

FIG. 8 illustrates motions of the workpiece and the tool in the interpolation cutting in which the workpiece of FIG. 7 is not caused to make one rotation;

FIG. 9 illustrates velocities and accelerations of a workpiece rotation axis Cw, a tool rotation axis Ct, a movement axis X, and a movement axis Y in a third example in which a movement route determination process according to an embodiment of the present disclosure is applied to interpolation cutting in which a workpiece is not caused to make one rotation;

FIG. 10 illustrates velocities and accelerations of a workpiece rotation axis Cw, a tool rotation axis Ct, a movement axis X, and a movement axis Y in a fourth example in which a movement route determination process according to an embodiment of the present disclosure is applied to interpolation cutting in which a workpiece is not caused to make one rotation;

FIG. 11 is a diagram illustrating a conventionally typical turning process;

FIG. 12 is a diagram illustrating interpolation cutting; and

FIG. 13 is a diagram illustrating a case where a workpiece is also rotatable in interpolation cutting.

### PREFERRED MODE FOR CARRYING OUT THE INVENTION

Embodiments of the present disclosure will be described below in detail with reference to the drawings.

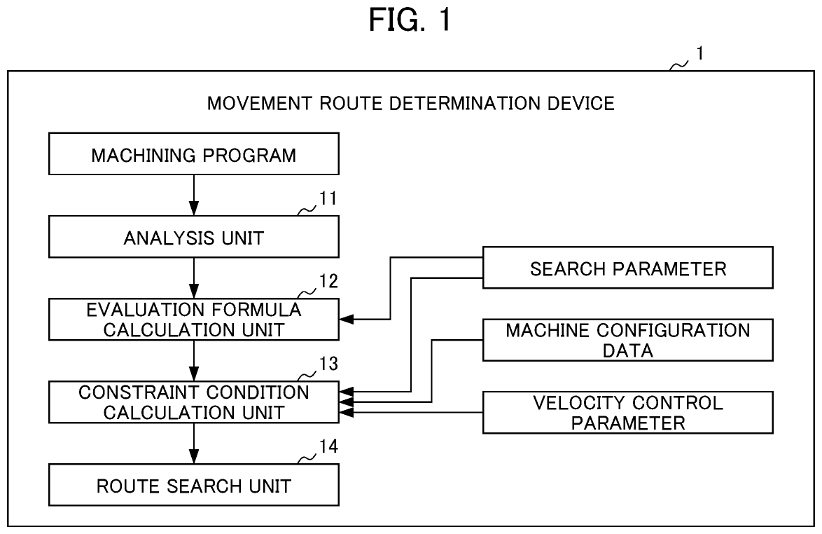

FIG. 1 is a diagram illustrating a configuration of a movement route determination device 1 according to an embodiment of the present disclosure. The movement route determination device 1 according to the present embodiment is a device for determining a movement route for the axes of a machine tool in, for example, interpolation cutting. More specifically, the movement route determination device 1 according to the present embodiment is capable of determining a movement route for axes based on a machining program and a parameter in a case where a degree of freedom of the axes of the machine tool is higher than a degree of freedom determined by the machining program and the parameter, i.e., in a case where the movement route for the axes is not uniquely determined due to the excess of the degrees of freedom of the axes.

Specifically, the movement route determination device 1 according to the present embodiment sets an evaluation formula for determining the movement route, and optimizes and determines the route for the axes such that the set evaluation formula is minimized or maximized under a constraint condition that is based on a relational expression of the axes of the machine tool. In this way, the movement route determination device 1 of the present embodiment can optimize the movement route for the axes in a machine configuration having an excess degree of freedom.

The movement route determination device 1 according to the present embodiment may use any optimization algorithm without particular limitation. For example, quadratic programming to be described later can be used. The quadratic programming is a method of optimizing (minimizing or maximizing) an evaluation formula represented by a quadratic function having several variables under linear constraints. The movement route determination device 1 according to the present embodiment may be installed in a computer numerical controller (CNC), or may be provided in, for example, computer aided manufacturing (CAM) that creates a machining program for NC based on shape data created by CAD as input data, instead of the CNC.

For example, the movement route determination device 1 includes a computer provided with memory such as a read only memory (ROM) and a random access memory (RAM), a control processing unit (CPU), and a communication control unit that are connected to each other via a bus. As illustrated in FIG. 1, the movement route determination device 1 according to the present embodiment includes an analysis unit 11, an evaluation formula calculation unit 12, a constraint condition calculation unit 13, and a route search unit 14. The functions and operations of these units can be implemented by way of cooperation of the CPU and the memory mounted in the computer, as well as a control program stored in the memory.

The movement route determination device 1 is connected to an external computer (not shown), such as a computer numerical controller (CNC) (in a case where the movement route determination device 1 is installed in equipment such as CAM other than the CNC), and a programmable logic controller (PLC). From these external computers, a machining program, a machining parameter, machine configuration data, and the like are inputted to the movement route determination device 1.

The analysis unit 11 analyzes the machining program inputted to the movement route determination device 1. By analyzing the machining program, the analysis unit 11 acquires information regarding machining conditions that are specified by the machining program, and that include a contour shape (hereinafter referred to also as the contour machining route) of a workpiece, positions for axes, a relative velocity of a tool with respect to the workpiece, etc. The result of the analysis of the machining program by the analysis unit 11 is transmitted to the evaluation formula calculation unit 12, the constraint condition calculation unit 13, and the route search unit 14, which will be described later.

The evaluation formula calculation unit 12 calculates an evaluation formula for determining the movement route for axes. Preferably, the evaluation formula calculation unit 12 calculates, as the evaluation formula, a function having at least one of a position, a velocity, an acceleration, or a jerk of the axes. The evaluation formula calculated and set by the evaluation formula calculation unit 12 is outputted to the constraint condition calculation unit 13 and the route search unit 14, which will be described later.

The evaluation formula calculation unit 12 preferably sets the evaluation formula based on a search parameter. Examples of the search parameter include a weight that is set for each axis in the evaluation formula. That is, the evaluation formula calculation unit 12 preferably calculates, as the evaluation formula, a function that multiplies the weight for each axis. It should be noted that the search parameter is inputted in advance to the movement route determination device 1, stored in a storage unit (not shown), and acquired from the storage unit, for example.

For example, in a case where the acceleration and deceleration of a workpiece rotation axis is to be suppressed, the sum of integrated acceleration values of the respective axes is set as the evaluation formula, and the weight for a term relating to the workpiece rotation axis is set to a value larger than the weights for the other axes. As a result, the acceleration and deceleration of the workpiece rotation axis become costly, and the movement route for each axis is optimized accordingly, whereby the acceleration and deceleration of the workpiece rotation axis are suppressed.

The constraint condition calculation unit 13 calculates a relational expression of the axes that is based on the machine configuration data of the machine tool, as the constraint condition for determining the movement route for the axes. Specifically, the constraint condition calculation unit 13 preferably sets the constraint condition based on the contour shape, the search parameter, the machine configuration data, and a velocity control parameter. The contour shape is acquired from the result of the analysis by the analysis unit 11. The search parameter, the machine configuration data, and the velocity control parameter are inputted in advance to the movement route determination device 1, stored in the storage unit (not shown), and acquired from the storage unit, for example.

The constraint condition calculation unit 13 preferably calculates a constraint condition specified by the velocity control parameter. Examples of the velocity control parameter include a maximum allowable velocity, a maximum allowable acceleration, and a maximum allowable jerk.

The constraint condition calculation unit 13 preferably calculates a constraint condition related to positions of the axes specified by the search parameter. For example, as will be described later, in a case where an elliptic route is conceived as a movement route, and a linear constraint according to quadratic programming is to be provided, it is preferable to set an allowable change amount that limits an amount of change in the position for each axis so that the position for each axis after change can be represented by first-order approximation. The allowable change amount as the constraint condition is inputted in advance to the movement route determination device 1, stored in the storage unit (not shown), and acquired from the storage unit, for example.

The constraint condition calculation unit 13 preferably calculates a constraint condition related to a contour machining route specified by the machining program. For example, the constraint condition calculation unit 13 sets, as the constraint condition, an equation related to the contour machining route specified by the machining program. As a result, the route search unit 14, which will be described later, determines a movement route for the axes such that the contour machining route is passed through.

The route search unit 14 searches for the movement route for the axes, based on the evaluation formula and the constraint condition described above. Specifically, the route search unit 14 optimizes the evaluation formula such that the evaluation formula is minimized or maximized while the constraint condition is satisfied.

It is preferable that the calculation of the constraint condition by the constraint condition calculation unit 13 and the search for the movement route by the route search unit 14 are repeated a plurality of times, for the following reasons. In the case where the position after a minute change is first-order approximated whereby the amount of change in the position is limited, as described above, the position for each axis can be changed only slightly. Furthermore, if the positions for the respective axes are included in the constraint condition and the positions for the axes change, the constraint condition also needs to be updated. Thus, after the evaluation formula and the constraint condition have been set, it is necessary to sequentially repeat the process for optimization, updating of the positions, and updating of the constraint condition.

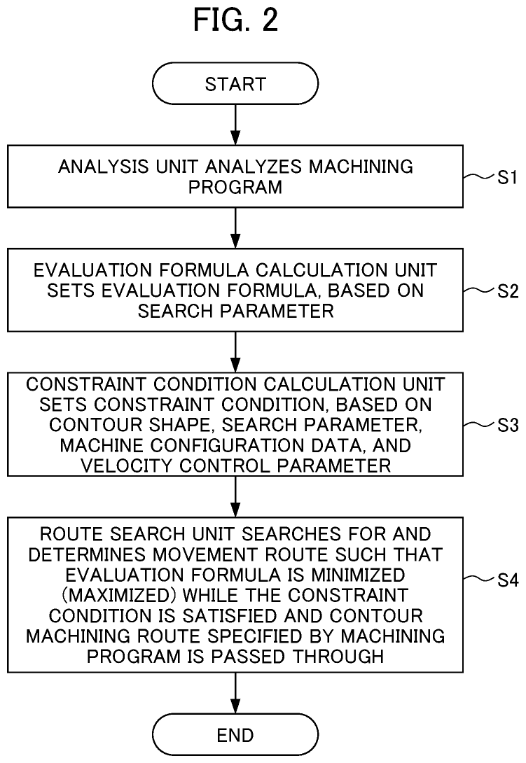

Next, a procedure of a movement route determination process according to the present embodiment will be described with reference to FIG. 2. FIG. 2 is a flowchart illustrating the procedure of the movement route determination process according to the present embodiment.

As illustrated in FIG. 2, first, in Step S1, the analysis unit 11 analyzes a machining program. By way of the analysis of the machining program by the analysis unit 11, information regarding machining conditions that are specified by the machining program, and that include a contour shape of a workpiece, positions for axes, a relative velocity of a tool with respect to the workpiece, etc. is acquired. After the analysis, the process proceeds to Step S2.

Next, in Step S2, the evaluation formula calculation unit 12 calculates and sets an evaluation formula for determining a movement route for the axes, based on a search parameter. An example of the evaluation formula is a function that multiplies at least one of a position, a velocity, an acceleration, or a jerk of the axes by a weight specified for each axis by the search parameter. After setting the evaluation formula, the process proceeds to Step S3.

Next, in Step S3, the constraint condition calculation unit 13 calculates and sets a constraint condition for determining the movement route for the axes, based on the contour shape, the search parameter, the machine configuration data, and the velocity control parameter. The constraint condition includes, for example, a constraint condition related to the positions for the axes. After setting the constraint condition, the process proceeds to Step S4.

Next, in Step S4, the route search unit 14 searches for and determines the movement route such that the evaluation formula is minimized or maximized while the constraint condition is satisfied and the contour machining route specified by the machining program is passed through. After the movement route has been searched for and determined, the present process ends.

In a case where a constraint condition related to the positions for the axes are included in the constraint condition, it is necessary to update the constraint condition because the positions for the axes change due to the search by the route search unit 14. Therefore, in this case, the calculation of the constraint condition by the constraint condition calculation unit 13 and the search for the movement route by the route search unit 14 are repeated a plurality of times, whereby the optimum movement route is searched for.

Next, the movement route determination process according to the present embodiment will be described in more detail with reference to a specific example.

Here, a machine tool that has a four-axis configuration including a workpiece rotation axis Cw, a tool rotation axis Ct, a movement axis X, and a movement axis Y is described as an example. Further, consider a case in which the machine tool having the four-axis configuration is used to machine a workpiece at a constant velocity along an elliptic route whose elliptic center deviates from the workpiece rotation center.

A function that multiplies the product of multiplication of the square of an acceleration of each axis and time by a weight for the axis as a search parameter is adopted as the evaluation formula. The weights for the axes as the search parameter are as follows: the weight for the workpiece rotation axis Cw is represented by Kcw, the weight for the tool rotation axis Ct is represented by Kct, the weight for the movement axis X is represented by Kx, and the weight for the movement axis Y weight is represented by Ky.

Examples of a constraint condition include a contour shape (e.g., an elliptic machining route to be described later) acquired by analyzing a machining program, the above-described weights (Kcw, Kct, Kx, Ky) for the respective axes as the search parameter, the above-described machine configuration data, and a constraint condition specified by a velocity control parameter. The velocity control parameter includes, for example, maximum allowable velocities for the respective axes and the maximum allowable accelerations for the respective axes. Here, the maximum allowable velocities for the respective axes are as follows: Vcw_max represents the maximum allowable velocity for the workpiece rotation axis Cw, Vct_max represents the maximum allowable velocity for the tool rotation axis Ct, Vx_max represents the maximum allowable velocity for the movement axis X, and Vy_max represents the maximum allowable velocity for the movement axis Y. The maximum allowable accelerations for the respective axes are as follows: Acw_max represents the maximum allowable acceleration for the workpiece rotation axis Cw, Act max represents the maximum allowable acceleration for the tool rotation axis Ct, Ax max represents the maximum allowable acceleration for the movement axis X, and Ay_max represents the maximum allowable acceleration for the movement axis Y.

An example of the machining conditions is as follows.

### [Machining Conditions]

Feedrate: 10 [mm/see]
Elliptic machining route:
Distance of 60 [mm] from the workpiece rotation center to the
elliptic center
Elliptic major axis of 80 [mm]
Elliptic minor axis of 50 [mm]
Tool length: 50 [mm]
Maximum allowed velocities for the respective axes: 500
[mm/sec] or 500 [degrees/sec]
Maximum allowed accelerations for the respective axes: 2000
[mm/sec²] or 2000 [degrees/sec²]

The positions for the axes are determined such that the evaluation formula is minimized when the tool tip point moves along the elliptic machining route in a given XY plane at a given feedrate. Specifically, a time T (20.7 [sec] under the above-described machining conditions) that the tool takes to make one revolution along the contour shape (elliptic machining route) of the workpiece is divided into n equal parts (n-part split), and the position for each axis at each of the n equal time parts can be represented as follows: the position for the workpiece rotation axis Cw is represented as Cwᵢ (or Cw[i]; the same applies to the following), the position for tool rotation axis Ct is represented as Ctᵢ, the position for the movement axis X is represented as Xᵢ, and the position for the movement axis Y is represented as Yᵢ. In this case, i=0, 1, . . . , n. For example, when the time T is divided into 200 equal parts, the positions for the workpiece rotation axis Cw at the 200 equal parts can be represented as Cw₀, Cw₁, . . . , CW₂₀₀. This applies also to the tool rotation axis Ct, the movement axis X, and the movement axis Y.

Next, a vector v is defined as in the following Formula (1), and the vector v that minimizes the evaluation formula under the constraint condition is calculated. In the Formula (1), T represents transposition.

$$\begin{matrix}[ Formula 1 ] & \\ {v}^{T} = ( \begin{matrix}{Cw}_{0} & ⋯ & {Cw}_{n} & {Ct}_{0} & ⋯ & {Ct}_{n} & {X}_{0} & ⋯ & {X}_{n} & {Y}_{0} & ⋯ & {Y}_{n}\end{matrix} & Formula 1\end{matrix}$$

Here, the acceleration for each axis at each position can be expressed by the position for the axis. For example, the acceleration Acwᵢ (i=0, 1, . . . , n) for the workpiece rotation axis Cw can be expressed by the following Formula (2). Specifically, since a difference between positions is a velocity and a difference between velocities is an acceleration, the acceleration Acwᵢ can be expressed by calculus of finite differences, as in Formula (2). This applies also to the acceleration Actᵢ for the tool rotation axis Ct, the acceleration Axᵢ for the movement axis X, and the acceleration Ayᵢ for the movement axis Y. Note that Δt in Formula (2) is represented by Δt=T/n.

$$\begin{matrix}[ Formula 2 ] & \\ {Acw}_{i} = ( C {w}_{i + 1} - {Cw}_{i} ) / Δ {t}^{2} - ( {Cw}_{i} - {Cw}_{i - 1} ) / Δ {t}^{2} & Formula 2\end{matrix}$$

The evaluation formula, which is a function that multiplies the products of multiplication of the square of an acceleration of the axes and time by the weights for the respective axes, can be expressed by the following Formula (3).

$$\begin{matrix}[ Formula 3 ] & \\ {\sum }_{0 \leq i \leq n} ( {kcwAcw}_{i}^{2} + {kctAct}_{i}^{2} + {kxAx}_{i}^{2} + {kyAy}_{i}^{2} ) & Formula 3\end{matrix}$$

Thus, the evaluation formula can be described as the following Formula (4), based on the Formula (2) and the Formula (3).

$$\begin{matrix}[ Formula 4 ] & \\ {\sum }_{0 \leq i \leq n} ( {kcwAcw}_{i}^{2} + {kctAct}_{i}^{2} {kxAx}_{i}^{2} + {kyAy}_{i}^{2} ) = \frac{1}{2} {v}^{T} Pv + {q}^{T} v + c & Formula 4\end{matrix}$$

In Formula (4), P is a symmetrical matrix and is a second order term of the position for each axis. In Formula (4), q is a vector and is a first order term of the position for each axis.

Next, a case where the vector v is changed by a minute amount is considered. In this example, since the number of degrees of freedom of the axes is larger by one degree, if the position for one of the axes is determined at a certain time, the positions for the remaining axes are then determined. For example, if Cw at a certain time is determined, the position for each of the other axes can be expressed as a function of Cw, such as Ctᵢ(Cw), Xᵢ(Cw), and Yᵢ(Cw).

Accordingly, the positions after the minute change can be given by the following Formulas (5) to (7) by way of first-order approximation. The position before the change is marked with an underbar (“_”).

$$\begin{matrix}[ Formula 5 ] & \\ {Ct}_{i} = {\_CT}_{i} + \frac{dCt ( {\_Cw}_{i} )}{dCw} ( {Cw}_{i} - {\_Cw}_{i} ) & Formula 5\end{matrix}$$

$$\begin{matrix}[ Formula 6 ] & \\ {X}_{i} = {\_X}_{i} + \frac{dX ( {\_Cw}_{i} )}{dCw} ( {Cw}_{i} - {\_Cw}_{i} ) & Formula 6\end{matrix}$$

$$\begin{matrix}[ Formula 7 ] & \\ {Y}_{i} = {\_Y}_{i} + \frac{dY ( {\_Cw}_{i} )}{dCw} ( {Cw}_{i} - {\_Cw}_{i} ) & Formula 7\end{matrix}$$

Since the starting point and the endpoint are fixed, Cw₀=_Cw₀, and Cw₂₀₀=_Cw₂₀₀. This applies also to Ct, x, and Y. Accordingly, the foregoing is summarized in that the constraint formula (equation) can be expressed by the following Formula (8) using a matrix A and a vector b.

$$\begin{matrix}[ Formula 8 ] & \\ Av = b & Formula 8\end{matrix}$$

Incidentally, since the position after the change is expressed by way of first-order approximation, it is necessary to limit the amount of change. An allowable change amount for Cw from the position before the change is defined as ΔCw, and it is necessary to satisfy the inequality expressed by the following Formula (9) as a constraint formula.

$$\begin{matrix}[ Formula 9 ] & \\ - {Cw}_{i} - Δ Cw \leq {Cw}_{i} \leq {\_Cw}_{i} + Δ Cw & Formula 9\end{matrix}$$

Furthermore, the conditions for the maximum allowable velocity and the maximum allowable acceleration of each axis can also be described by a linear expression, and can be expressed as a constraint condition of an inequality using a matrix G and a vector h, as shown in the following Formula (10).

$$\begin{matrix}[ Formula 10 ] & \\ Gv \leq h & Formula 10\end{matrix}$$

Thus, formulation can be achieved using the second-order evaluation formula of a position C of each axis represented by Formula (4), the equation as a first-order constraint expression of the position C of each axis represented by Formula (8), and the inequality as a first-order constraint expression of the position C of each axis represented by Formula (10). Therefore, the vector v can be optimized by quadratic programming.

Since the position after the minute change is first-order approximated, Cw can be changed only slightly. Therefore, after the evaluation formula and the constraint condition have been set, it is necessary to sequentially repeat the process for optimization, updating of the positions, and updating of the constraint condition. This is because the positions for the respective axes are included in the constraint condition, and if the positions of the respective axes change, the constraint condition needs to be updated.

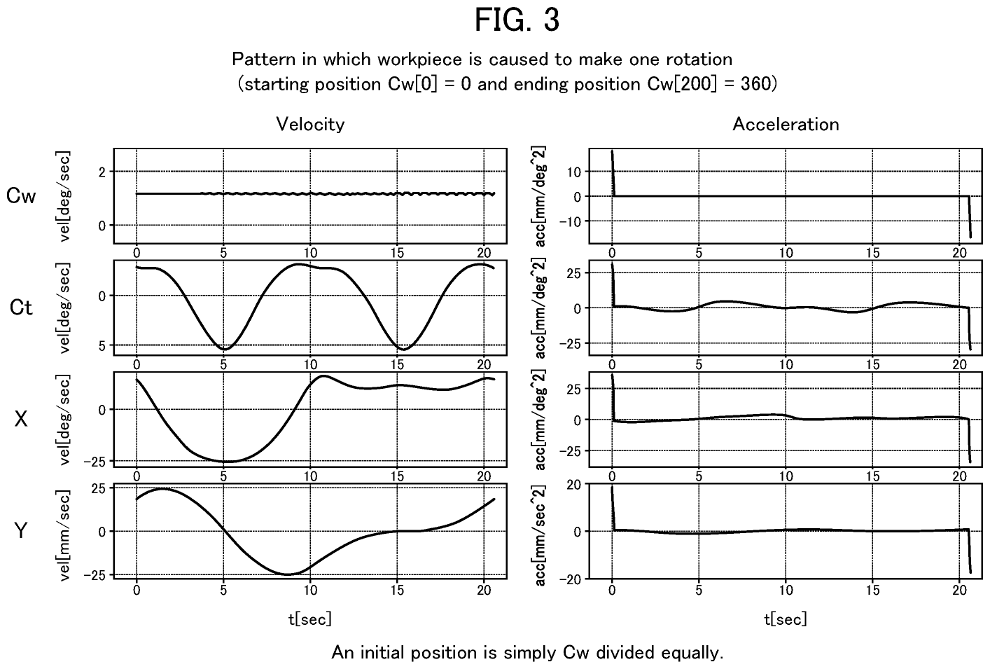

Next, an example in which the movement route determination process according to the present embodiment is applied to interpolation cutting will be described in detail with reference to FIGS. 3 to 10.

FIG. 3 illustrates velocities and accelerations for a workpiece rotation axis Cw, a tool rotation axis Ct, a movement axis X, and a movement axis Y in interpolation cutting in which a workpiece W is caused to make one rotation. Specifically, FIG. 3 illustrates, in the case of the interpolation cutting in which the workpiece is caused to make one rotation under conditions that the starting position Cw[0]=0 and the ending position Cw=360, the velocity and acceleration for the workpiece rotation axis Cw, those for the tool rotation axis Ct, those for the movement axis X, and those for the movement axis Y when an initial position is simply the position for the workpiece rotation axis Cw divided equally.

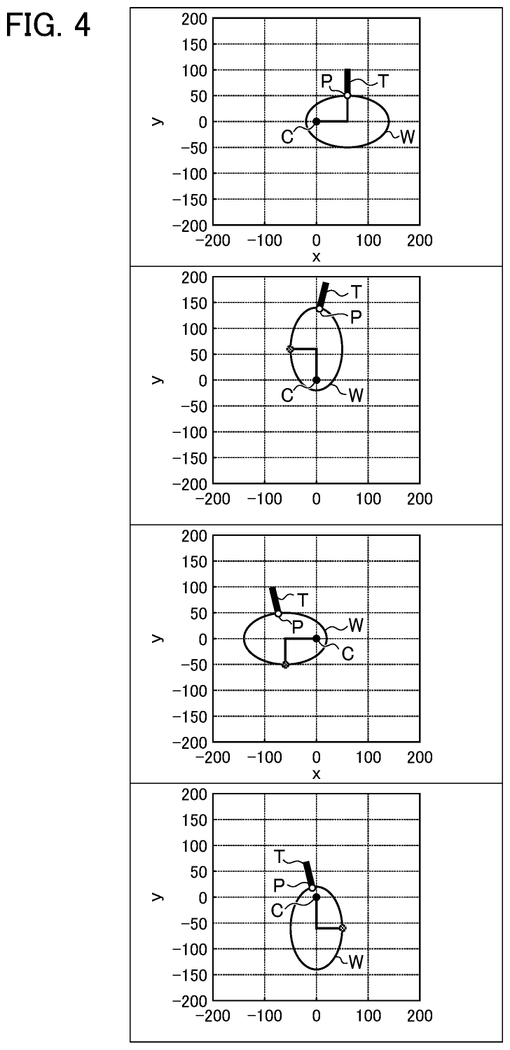

FIG. 4 illustrates motions of the workpiece W and the tool T in the interpolation cutting in which the workpiece W of FIG. 3 is caused to make one rotation. Specifically, in FIG. 4, the positions of the workpiece W and the tool T in a period in which the workpiece W makes one rotation are illustrated every 90 degrees in a divided manner. It can be appreciated from FIG. 4 that while the workpiece W makes one rotation, the tool T and the cutting point P make one revolution along the elliptic route which corresponds to the outer periphery of the workpiece W and whose elliptic center deviates from the workpiece rotation center C.

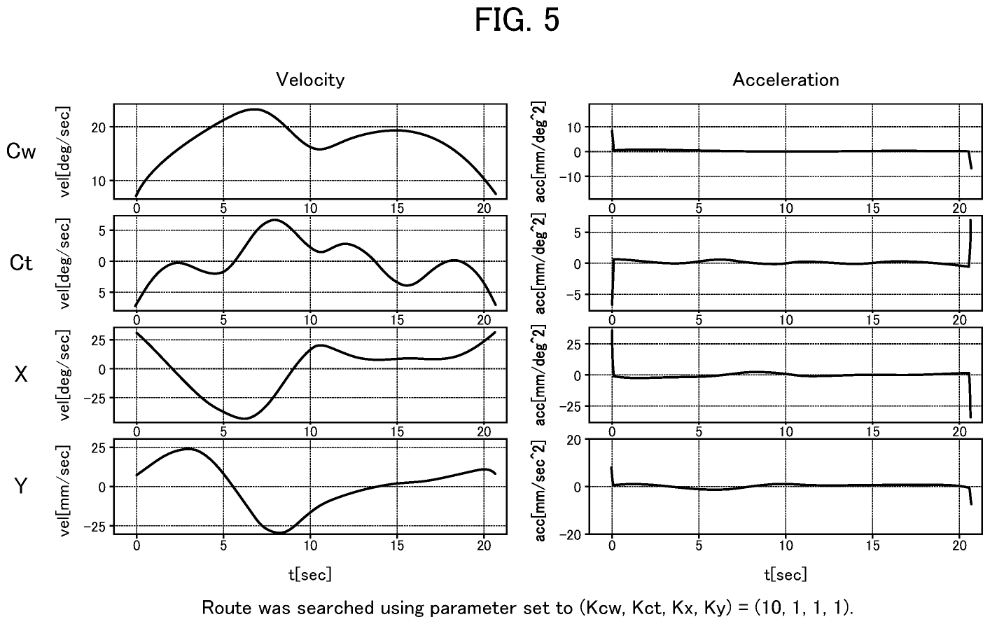

FIG. 5 illustrates velocities and accelerations for a workpiece rotation axis Cw, a tool rotation axis Ct, a movement axis X, and a movement axis Y in a first example in which a movement route determination process according to the present embodiment was applied to the interpolation cutting in which a workpiece W was caused to make one rotation. In the first example, the route search was performed with the weights for the respective axes, which are a search parameter, set to (Kcw, Kct, Kx, Ky)=(10, 1, 1, 1) so that the acceleration and deceleration of the workpiece rotation axis Cw became costly.

By performing the route search according to the first example, a route was determined which prevented or reduced acceleration and deceleration for the rotation axis of the workpiece W. As a result, as illustrated in FIG. 5, the acceleration and deceleration were suppressed so that the rotation speed for the workpiece W became as constant as possible.

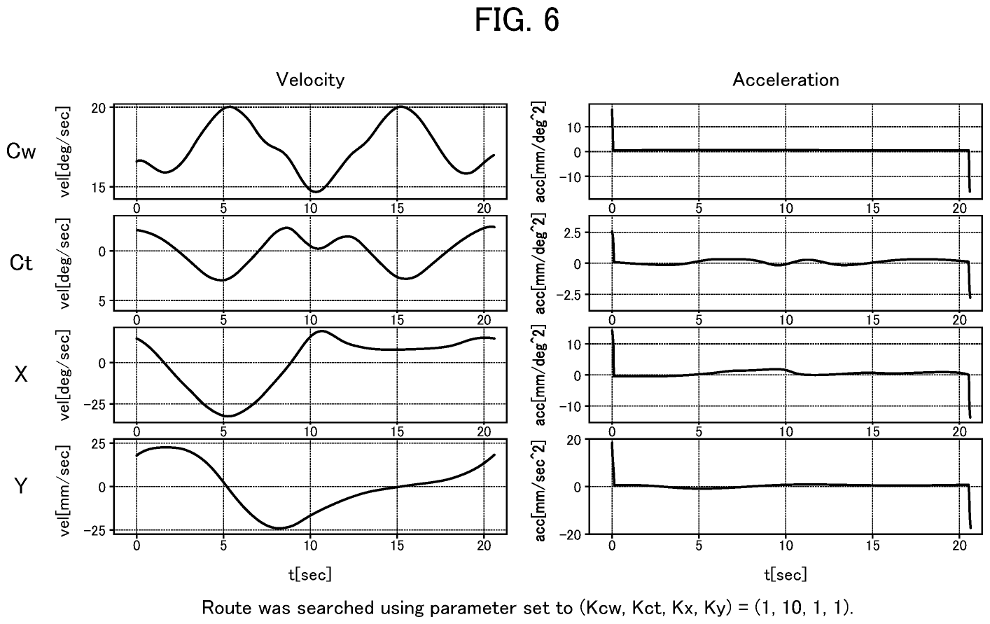

FIG. 6 illustrates velocities and accelerations for a workpiece rotation axis Cw, a tool rotation axis Ct, a movement axis X, and a movement axis Y in a second example in which the movement route determination process according to the present embodiment was applied to the interpolation cutting in which a workpiece W was caused to make one rotation. In the second example, the route search was performed with the weights for the respective axes, which are the search parameter, set to (Kcw, Kct, Kx, Ky)=(1, 10, 1, 1) so that the acceleration and deceleration of the tool rotation axis Ct became costly.

By performing the route search according to the second example, a route was determined which prevented or reduced acceleration and deceleration for the rotation axis of the tool T. As a result, as illustrated in FIG. 6, the acceleration and deceleration were suppressed so that the rotation speed of the tool T became as constant as possible.

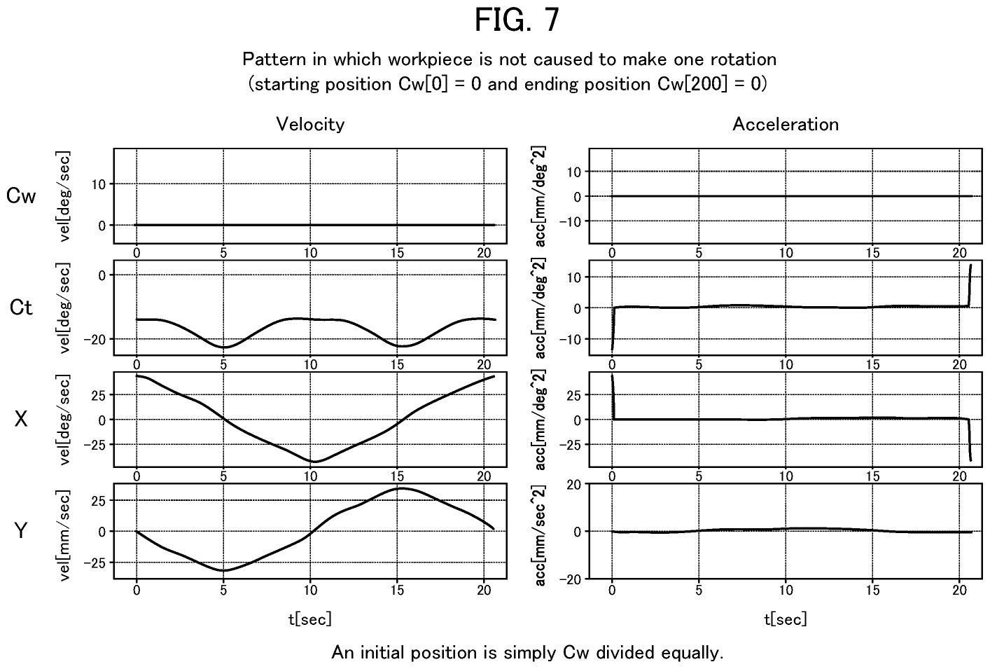

FIG. 7 illustrates velocities and accelerations for a workpiece rotation axis Cw, a tool rotation axis Ct, a movement axis X, and a movement axis Y in interpolation cutting in which a workpiece W is not caused to make one rotation. Specifically, FIG. 7 illustrates, in the case of the interpolation cutting in which the workpiece is not caused to make one rotation under conditions that the starting position Cw[0]=0 and the ending position Cw=0, the velocity and acceleration for the workpiece rotation axis Cw, those for the tool rotation axis Ct, those for the movement axis X, and those for the movement axis Y when an initial position is simply the position of the workpiece rotation axis Cw divided equally.

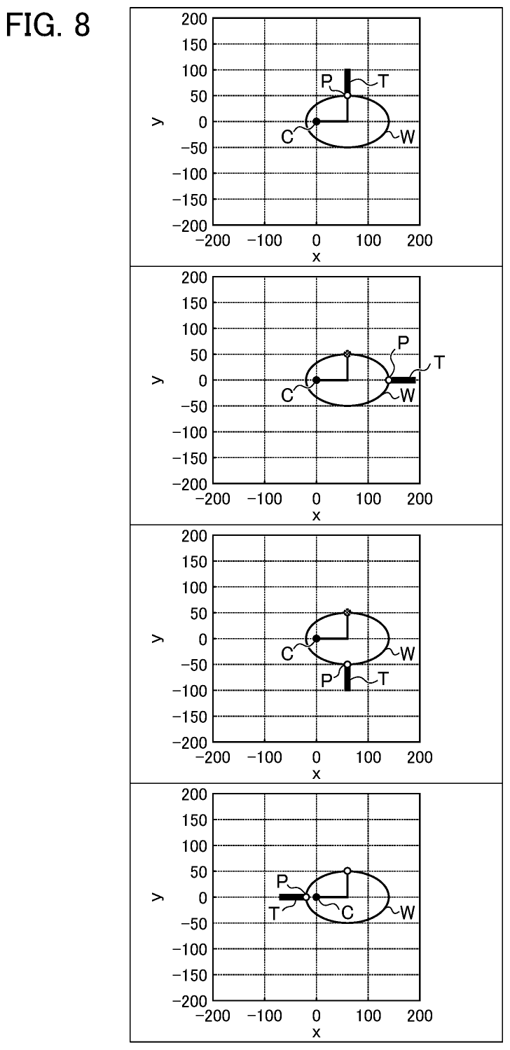

FIG. 8 illustrates motions of the workpiece W and the tool T in the interpolation cutting in which the workpiece W of FIG. 7 is not caused to make one rotation. Specifically, in FIG. 8, the positions of the workpiece W and the tool T in the case where the workpiece W does not make one rotation are illustrated every 90 degrees in a divided manner. It can be appreciated from FIG. 8 that the tool T and the cutting point P make one revolution along the elliptic route which corresponds to the outer periphery of the workpiece W and whose elliptic center deviates from the workpiece rotation center C of the workpiece W, which does not make one rotation.

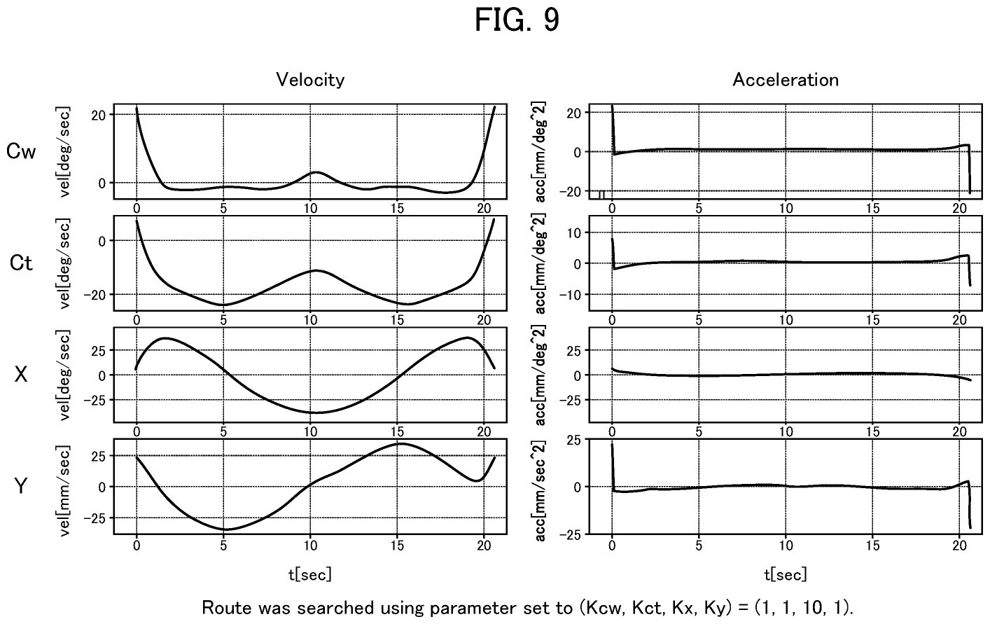

FIG. 9 illustrates velocities and accelerations for a workpiece rotation axis Cw, a tool rotation axis Ct, a movement axis X, and a movement axis Y in a third example in which the movement route determination process according to the present embodiment was applied to the interpolation cutting in which a workpiece W was not caused to make one rotation. In the third example, the route search was performed with the weights for the respective axes, which are the search parameter, set to (Kcw, Kct, Kx, Ky)=(1, 1, 10, 1) so that the acceleration and deceleration for the movement axis X became costly.

By performing the route search according to the third example, a route was determined which prevented or reduced acceleration and deceleration for the movement axis X. As a result, as illustrated in FIG. 9, the acceleration and deceleration were suppressed so that the velocity for the movement axis X became as constant as possible.

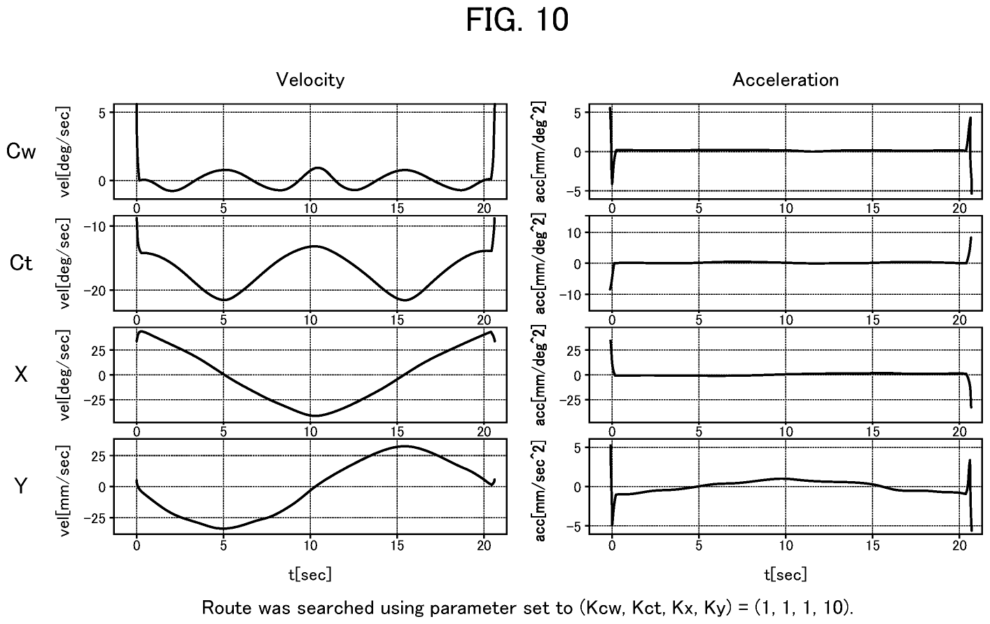

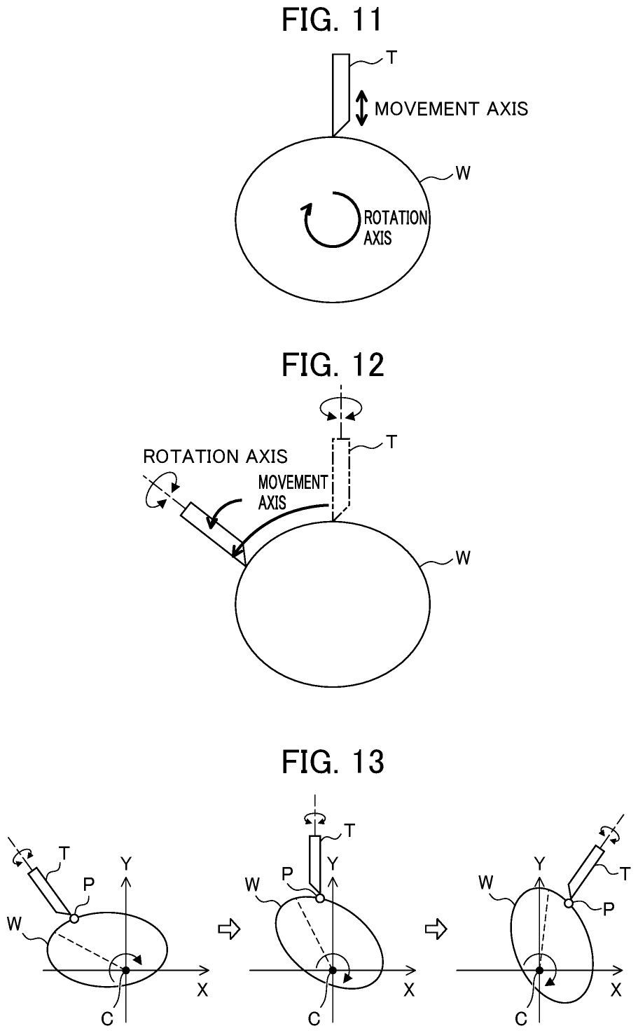

FIG. 10 illustrates velocities and accelerations for a workpiece rotation axis Cw, a tool rotation axis Ct, a movement axis X, and a movement axis Y in a fourth example in which the movement route determination process according to the present embodiment was applied to the interpolation cutting in which a workpiece was not caused to make one rotation; In the fourth example, the route search was performed with the weights for the respective axes, which are the search parameter, set to (Kcw, Kct, Kx, Ky)=(1, 1, 1, 10) so that the acceleration and deceleration for the movement axis Y became costly.

By performing the route search according to the fourth example, a route is determined which prevented or reduced acceleration and deceleration for the movement axis Y. As a result, as illustrated in FIG. 10, the acceleration and deceleration were suppressed so that the velocity for the movement axis Y became as constant as possible.

The movement route determination device 1 according to the present embodiment exerts the following effects.

The movement route determination device 1 according to the present embodiment includes: the evaluation formula calculation unit 12 that calculates an evaluation formula for determining a movement route; the constraint condition calculation unit 13 that calculates, as a constraint condition for determining the movement route, a relational expression of the axes, the relational expression being based on machine configuration data; and the route search unit 14 that searches for the movement route based on the evaluation formula and the constraint condition. In the present embodiment, the route search unit 14 determines the movement route such that the evaluation formula is minimized or maximized within a searchable range.

Due to this feature, even in a case where the degree of freedom of the axes of a machine tool is higher than a degree of freedom determined by a machining program and a machining parameter, a movement route for the axes can be optimized and the optimal movement route can be determined. In other words, according to the present embodiment, the route search unit 14 searches for and determines the movement route such that the evaluation formula is minimized or maximized while the constraint condition is satisfied, thereby making it possible to determine the optimal movement route.

In the present embodiment, the evaluation formula calculation unit 12 preferably calculates, as the evaluation formula, a function having at least one of a position, a velocity, an acceleration, or a jerk for the axes, and further preferably calculates a function that multiples weights for the respective axes. This feature makes it possible to further reliably optimize the movement route for the axes.

In the present embodiment, the constraint condition calculation unit 13 preferably calculates a constraint condition specified by a velocity control parameter, and further preferably calculates a constraint condition related to the positions for the axes. In this case, it is preferable to repeat the calculation of the constraint condition by the constraint condition calculation unit 13 and the search for the movement route by the route search unit 14 a plurality of times. This feature makes it possible to further reliably optimize the movement route for the axes.

It is preferable that in the present embodiment, the constraint condition calculation unit 13 calculates a constraint condition related to a contour machining route specified by the machining program. Thus, according to the present embodiment, the route search unit 14 searches for and determines the movement route such that the evaluation formula is minimized or maximized while the constraint condition is satisfied, and the contour machining route specified by the machining program is passed through. As a result, the machining (cutting) route is not changed, and the adverse effect on the machined (cut) surface can be avoided.

It should be noted that the present disclosure is not limited to the above-described embodiment, and modifications and improvements to the extent that the object of the present disclosure can be achieved are encompassed by the present disclosure.

For example, in the above embodiment, the case where the present disclosure is implemented by the movement route determination device 1 has been described, but the present disclosure is not limited thereto. The present invention can also be implemented by a computer program that causes a computer to perform the functions of the above-described movement route determination device 1.

### EXPLANATION OF REFERENCE NUMERALS

1: Movement route determination device
11: Analysis unit
12: Evaluation formula calculation unit
13: Constraint condition calculation unit
14 Route search unit

1. A movement route determination device that determines, in a case where a degree of freedom of axes of a machine tool is higher than a degree of freedom determined by a machining program and a parameter, a movement route for the axes based on the machining program and the parameter, the movement route determination device comprising:
an evaluation formula calculation unit configured to calculate an evaluation formula for determining the movement route;
a constraint condition calculation unit configured to calculate, as a constraint condition for determining the movement route, a relational expression of the axes, the relational expression being based on machine configuration data of the machine tool; and
a route search unit configured to search for the movement route based on the evaluation formula and the constraint condition, the movement route being such that the evaluation formula is minimized or maximized within a searchable range.

2. The movement route determination device according to claim 1, wherein
the evaluation formula calculation unit calculates, as the evaluation formula, a function having at least one of a position, a velocity, an acceleration, or a jerk for the axes.

3. The movement route determination device according to claim 1, wherein
the evaluation formula calculation unit calculates, as the evaluation formula, a function that multiplies weights for the respective axes.

4. The movement route determination device according to claim 1, wherein
the constraint condition calculation unit calculates a constraint condition specified by a velocity control parameter.

5. The movement route determination device according to claim 1, wherein
the constraint condition calculation unit calculates a constraint condition related to positions for the axes, and
calculation of the constraint condition by the constraint condition calculation unit and search for the movement route by the route search unit are repeated a plurality of times.

6. The movement route determination device according to claim 1, wherein
the constraint condition calculation unit calculates a constraint condition related to a contour machining route specified by the machining program.

7. A non-transitory computer-readable medium storing a computer program for a computer that determines, in a case where a degree of freedom of axes of a machine tool is higher than a degree of freedom determined by a machining program and a parameter, a movement route for the axes based on the machining program and the parameter, the non-transitory computer-readable medium storing the computer program causing the computer to perform operations that comprise:
calculating an evaluation formula for determining the movement route;
calculating, as a constraint condition for determining the movement route, a relational expression of the axes, the relational expression being based on machine configuration data of the machine tool; and
searching for the movement route based on the evaluation formula and the constraint condition, the movement route being such that the evaluation formula is minimized or maximized within a searchable range.
